(19) United States
(12) Patent Application Publication
(10) Pub. No.: US 2004/0258892 A1
(43) Pub. Date: Dec. 23, 2004

(54) Adhesive tape resistant to high temperatures

(75) Inventors: Alain Goux, Nievroz (FR); David Grapotte, Bourg-Les-Valence (FR)

Correspondence Address: IP DEPARTMENT OF PIPER RUDNICK LLP, ONE LIBERTY PLACE, SUITE 4900, 1650 MARKET ST, PHILADELPHIA, PA, 19103, US

(73) Assignee: Scapa France, a corporation of France, Bellegarde sur Valserine (FR)

(21) Appl. No.: 10/872,092

(22) Filed: Jun. 18, 2004

Related U.S. Application Data
(63) Continuation of application No. PCT/FR02/04511, filed on Dec. 20, 2002.

(30) Foreign Application Priority Data
Dec. 21, 2001 (FR) 01/16727

(51) Int. Cl. B32B 27/08

(52) U.S. Cl. 428/200; 428/515; 428/42.3; 428/214

(57) ABSTRACT

A multilayer adhesive tape including a single-layer or multilayer support layer including a first polypropylene resin and/or an ethylene/propylene copolymer and at least a second polyehtylene resin, ethylene copolymer and/or elastomer, at least one of these resins being an elastomer; and an adhesive composition layer adhered to at least one surface of the support layer, the support layer and/or the adhesive composition layer comprising at least one stabilizer.

### RELATED APPLICATION

This is a continuation of International Application No. PCT/FR02/04511, with an international filing date of Dec. 20, 2002 (WO 03/054101, published Jul. 3, 2003), which is based on French Patent Application No. 01/16727, filed Dec. 21, 2001.

### FIELD OF THE INVENTION

This invention relates to a new adhesive tape resistant to high temperatures used as sheathing for cables in the fields of the automotive, electrical and electronic industries, and for sheathing pipelines.

### BACKGROUND

The protection of cables and pipelines is traditionally implemented using adhesive tapes that differ from each other in their physical resistances and resistance to temperature. The most widely used products are adhesive tapes with a support based on polyvinyl chloride or polyolefins such as polyethylene or polypropylene, covered by an adhesive layer.

Tapes made of polyvinyl chloride (PVC) are widely used in the automotive industry because they exhibit good flame resistance properties. However, they are not highly resistant to high temperatures. They are therefore generally used in applications involving temperatures that remain between 85 and 105° C. Furthermore, PVC films are very sensitive to physical degradation. PVC is by nature rigid. Thus, it is generally plasticized to respond to this type of application (flexible tape). However, the plasticizers migrate in the film. This causes an accelerated embrittlement of the film and a softening of the adhesive. Furthermore, PVC by its very nature contains halogens (chlorine). It releases toxic vapors of chlorinated derivatives when it is combusted during incineration operations which can corrode recycling installations and pollute the atmosphere. PVC is therefore not readily recyclable. PVC is often replaced by other polymers for all of these reasons.

Adhesive tapes made of polypropylene (PP) exhibit good resistance to high temperatures, but they are known for weakness in their physical resistance under other extreme conditions to which they are subjected. Notably, PP tapes rapidly become embrittled under the effects of stretching, tension or flexion to which they are generally subjected.

Adhesive tapes made of polyethylene (PE) exhibit good performance at low temperatures, but exhibit poor resistance in applications when they are subjected to temperatures higher than 115° C.

WO 00/71364 discloses tapes having a temperature resistance performance of 3000 hours at 85° C. These tapes contain a film combining an ethylene/styrene thermoplastic copolymer with a thermoplastic polyolefin such as low-density PE or PP. An interpolymer is a particular type of copolymer in which the two monomers (at least two) are so tightly linked in the polymer molecule that the substance is essentially homogeneous in terms of chemical composition. This tightly linked structure however only enables a relatively weak resistance to high temperature.

It would therefore be advantageous to provide an adhesive tape which responds simultaneously to multiple criteria, i.e., that it is resistant to temperatures higher than 115° C., exhibits good physical resistance over time and is readily recyclable.

### SUMMARY OF THE INVENTION

This invention relates to a multilayer adhesive tape including a single-layer or multilayer support layer including a first polypropylene resin and/or an ethylene/propylene copolymer and at least a second polyethylene resin, ethylene copolymer and/or elastomer, at least one of these resins being an elastomer; and an adhesive composition layer adhered to at least one surface of the support layer, the support layer and/or the adhesive composition layer including at least one stabilizer.

### DETAILED DESCRIPTION

The deficiencies described above are overcome by the single-layer or multilayer adhesive tape according to aspects of the invention which is capable of preserving its physical properties at a temperature equal to 125° C. for about 3000 hours and at 150° C. for about 240 hours. The tape comprises a support layer on at least one surface of which adheres at least one layer notably of adhesive composition, wherein the support layer comprises a first polypropylene resin and/or an ethylene/propylene copolymer and at least a second polyethylene resin, ethylene copolymer and/or elastomer, at least one of the resins of the support layer being an elastomer resin and the support layer and/or the adhesive composition comprising at least one stabilizer. The support layer preferably contains at least about 60%, preferably from about 60 to about 90%, most preferably from about 65 to about 75%, of a polypropylene and/or ethylene/propylene copolymer resin.

Advantageously, neither the support layer nor the adhesive composition layer contains halogen compounds.

The content of ethylene monomer in the ethylene/propylene copolymer used for the first support resin is preferably comprised between about 1.5 and about 50%, more preferably between about 5 and about 30%, by weight.

The elastomer resin used for the second resin of the support is advantageously a styrene-isoprene-styrene (SIS) resin, a styrene-ethylene-butadiene-styrene (SEBS) resin, a styrene-ethylene-butadiene (SEB) resin, a styrene-ethylene-butadiene-styrene/styrene-ethylene-butadiene (SEBS/SEB) resin, a styrene-butadiene-styrene (SBS) resin, an ethylene-propylene-diene monomer (EPDM) resin and/or an ethylene-propylene rubber (EPR) resin.

According to a preferred embodiment, the stabilizer is a primary antioxidant used alone or in combination with a secondary antioxidant. The stabilizer(s) is(are) selected for their capacities to provide the composition of the invention with temperature stability and not for their anti-yellowing properties. Hence, according to one aspect of the invention, non-yellowing stabilizers are excluded from the stabilizers. The primary antioxidant is preferably a hindered phenol and/or a hindered amine. The secondary antioxidant is advantageously an organic phosphite, an organic phosphinite, an organic sulfide or a thio compound of the type dialkyldithiocarbamate or dialkyldithiophosphate, distearylthiodipropionate or a mixture of thereof.

According to a preferred embodiment, the stabilizer is a hindered phenol combined with a phosphite or a thio compound. The stabilizer further preferably comprises a high-performance antioxidant.

According to another embodiment, the adhesive composition is not a natural or synthetic rubber. According to yet another embodiment, the adhesive composition is pressure sensitive. The adhesive composition of the invention advantageously comprises an acrylic-based adhesive or a silicone-based adhesive. The adhesive composition is preferably a hot melt or thermoset adhesive. The adhesive composition can advantageously be cross-linked under the action of ultraviolet radiation or electron bombardment.

The adhesive composition preferably comprises a hot melt acrylic adhesive cross-linkable under the action of ultraviolet radiation of the type distributed by BASF as acResin® or an adhesive in solution of the type distributed by UCB as Solucryl® or of the type distributed by Ashland as AROSET® or of the type distributed by National Starch Chemical Company as DUROTAK® or an adhesive in emulsion of the type distributed by UCB as Ucécryl® or of the type distributed by Rohm & Haas as Primal® or of the type distributed by Solutia as Gelva® GME.

According to one embodiment, the adhesive composition is modified by a tackifier resin, the content of tackifier resin being less than about 30% by weight in relation to the weight of the adhesive composition, and preferably less than about 20% by weight in relation to the weight of the adhesive composition.

The support and/or the adhesive composition of the tape advantageously comprise(s) colorants or preferably mineral pigments, preferably carbon black, zinc oxide, magnesium oxide or titanium oxide and/or fillers, preferably calcium carbonate or talc.

The support and/or the adhesive composition preferably comprise(s) at least one halogen-free flame retardant agent. This halogen-free flame retardant agent is preferably alumina trihydrate, zinc borate, magnesium hydroxide, an organic polyphosphate, an ammonium polyphosphate and/or a triazine derivative.

According to a particularly preferred embodiment, in addition to the support and the adhesive, the tape comprises a primary bonding layer located between the support and the adhesive composition layer. The tape advantageously comprises a primary layer of an antiadherent agent on the support surface opposite the surface coated with the primary bonding layer and/or the layer(s) of adhesive composition.

According to an advantageous embodiment, at least one of the surfaces of the support is subjected to a corona surface treatment between about 34 and about 46 dyne/cm prior to application of the antiadherent layer, the primary bonding layer and/or the layer(s) of the adhesive composition.

Preferably, the thickness of the adhesive tape is comprised between about 50 and about 200 microns, preferably between about 60 and about 180 microns, and even more preferably between about 70 and about 150 microns.

The adhesive tape according to the invention can be used in the automotive, electrical and electronic sectors, wherein a bundle of wires is sheathed with the adhesive tape of the invention.

A better understanding of the invention will be obtained from the detailed description of particular embodiments of the invention and the examples below which illustrate selected aspects of the invention in a nonlimitative manner.

Degradation of the polymers constituting the supports of adhesive tape over time is generally due to oxidation phenomena which are dependent on a certain number of parameters, particularly the temperature to which these polymers are subjected. The degradation steps that come into play are principally due to mechanisms involving radicals.

The presence of a thermal source leads to formation of free radicals in the polymer resulting from decomposition of hydrocarbon bonds. In the presence of oxygen, this decomposition is combined with oxidation of the hydrocarbon bond which leads to formation of hydroperoxides (triggering phase of the radical reaction). Auto-oxidation is established from the radicals created in this manner, which leads to degradation of the polymer. Certain polymers are more sensitive than others to this type of degradation.

We endeavored to retard the thermal degradation phenomena to the maximum extent possible by attempting to stabilize the polymers and/or the adhesive compositions. We selected polymers that themselves exhibit good high-temperature performance. Thus, we selected resins based on polypropylene, preferably polypropylene and/or an ethylene/propylene copolymer, exhibiting good high-temperature performance. This copolymer can be a statistical copolymer or in the form of monomer blocks.

Since polypropylene is by its nature rigid, it cannot by itself constitute a flexible tape. In order to make it flexible, we added an ethylene/propylene copolymer, but especially added at least one second resin constituted of high-density and/or low-density polyethylene, an ethylene and/or elastomer copolymer, one of the resins constituting this support layer being necessarily an elastomer. Here also the copolymer can be statistical or in blocks.

The preferred ethylene copolymers are ethylene-vinyl acetate (EVA) copolymer, ethylene-methyl acrylate (EMA) copolymer, ethylene-ethyl acrylate (EEA) copolymer or ethylene-acrylic acid (EAA) copolymer.

The preferred elastomers are a styrene-isoprene-styrene (SIS) resin, a styrene-ethylene-butadiene-styrene (SEBS) resin, a styrene-ethylene-butadiene (SEB) resin, a styrene-butadiene-styrene (SBS) resin, an ethylene-propylene-diene-monomer (EPDM) and/or an ethylene-propylene-rubber (EPR) resin. A particularly preferred resin is a styrene-ethylene-butadiene-styrene/styrene-ethylene-butadiene (SEBS/SEB) resin.

However, we discovered that the mere presence of a polypropylene resin and/or an ethylene/propylene copolymer and of a polyethylene, an ethylene copolymer and/or an elastomer was not sufficient with regard to the physical resistance of the tape to high temperature over a long duration of time. It is for this reason that the tape also comprises stabilizers in the support and/or in the adhesive composition.

Two principal types of stabilizers retard the phenomena of degradation of the support and of the adhesive composition of the tape: primary antioxidants which react with a certain type of free radicals formed during the triggering phase of the radical reaction or stemming from the decomposition of the hydroperoxides, in particular radicals of the O. type (notably HO., RO. and ROO. groups in which R is an alkyl) and secondary antioxidants which retard the formation of the radicals by destroying the hydroperoxides during the triggering step without advancing via the radical route.

The primary antioxidants are hindered phenols or hindered amines. The hindered phenols are preferably 2,4-t-butyl-parahydroxy-toluene, octadecyl-3-(3,5-di-tertiobutyl-4-hydroxyphenyl) propionate, pentaerythritol tetrakis (3-(3,5-di-tertiobutyl-4-hydroxyphenyl) propionate, N,N′-hexane-1,6-diylbis (3-(3,5-di-tert-butyl-4-hydroxyphenylpropionamide)), 4-6-bis (octylthiomethyl)-o-cresol, ethylenebis (oxyethylene) bis-(3-(5-tert-butyl-4-hydroxy-m-tolyl) propionate), 2,6-ditertiary butyl paracresol, bis-[2-hydroxy-5-methyl-3-1 (1-methyl-cyclohexyl)-phenyl]-methane and/or 4,4′-butyldenebis (6-tert-butyl-m-cresol). The hindered amines are preferably bis (2,2,6,6-tetramethyl-a-piperidyl) sebacetate or poly[[6-[(1,1,3,3-tetramethylbutyl)amino]-1,3,5-triazine-2,4-diyl][(2,2,6,6-tetramethyl-4-piperidinyl) imino]-1,6-hexanediyl [(2,2,6,6-tetramethyl-4-piperidinyl) imino]].

The secondary antioxidants are an organic phosphite, an organic phosphinite, an organic sulfide or a thio compound of the type dialkyldithiocarbamate or dialkyldithiophosphate, distearylthiodipropionate or a mixture of these compounds.

The invention exhibits an interesting synergy phenomenon between a primary antioxidant and a secondary antioxidant when they are both used simultaneously to stabilize the polymers constituting the tape according to the invention. The phosphites and thio esters in particular have a synergistic effect with the hindered phenols.

We determined that the degradation phenomena of the tape are concentrated in an interfacial zone at the level of the contact between the layer of adhesive composition (or the primary bonding layer) and the support layer. The free radicals are present in larger quantities in this interfacial zone and the propagation reactions quickly lead to a degradation of the tape as a whole. The inventors then demonstrated that the stabilizers selected according to the invention, i.e., the combination of a primary stabilizer and a secondary stabilizer, in particular the combination of a hindered phenol with a phosphite or a thio compound, drastically diminishes these high-temperature degradation phenomena. We discovered that these particular stabilizers have a dual function in their application of stabilizing the support and/or the adhesive composition: on the one hand to prevent or retard formation of free radicals and on the other hand to couple with the free radicals formed at the level of the interfacial zone to prevent their propagation. They are thus particularly effective and their presence is needed to obtain the desired result.

The tape according to the invention can also comprise a high-performance antioxidant preferably in combination with a mixture of antioxidants as previously mentioned to stabilize the support and/or adhesive composition. The term “high-performance antioxidant” is understood to mean an antioxidant that intervenes to prevent formation and/or propagation of free radicals of general formula R., in which R is an alkyl. The preferred high-performance antioxidant is a lactone, 5,7-di-t-butyl-3-(3,4-dimethylphenyl)-3-H-benzofuran-2-one.

After carrying out experiments on a large variety of supports and of adhesive compositions, we discovered that rubber-based adhesives were particularly sensitive to thermal degradation. We also discovered that in the absence of stabilizer the degradation of rubber caused a large amount of free radicals that attacked the polypropylene support and accelerated aging and degradation of the support. Because rubber compounds produce such large amounts of free radicals, they are excluded from the adhesives selected for the implementation of the adhesive tape according to the invention.

In contrast, we discovered that the polyacrylic-based pressure sensitive adhesives and the silicone-based adhesives are particularly suitable for manufacturing the tape according to the invention. These adhesives are preferably stabilized by means of the stabilizers used for the supports and described above. These adhesives can be hot melt or thermoset adhesives. They can be cross-linkable under the action of ultraviolet radiation or by electron bombardment.

The adhesive composition of the invention can also contain a tackifier resin which increases the adhesive power of the adhesive.

The supports and/or adhesives used to manufacture an adhesive tape according to the invention advantageously comprise colorants, pigments and/or fillers. The colorants and pigments function to color the adhesive and support. A preferred pigment is carbon black, particularly demanded for applications in the automotive sector. The fillers have the function of increasing the volume of the support and/or adhesive to which they are added. It should be noted that some pigments play the same role as the fillers. The pigments and fillers also have a stabilization function. Carbon black can itself play an antioxidant role as an inhibitor of free radicals or influence the activity of an antioxidant by reinforcing it. These fillers and pigments can be integrated at the level of the support or at the level of the adhesive composition.

The support and/or the adhesive composition advantageously comprise(s) at least one halogen-free flame retardant. This compound is a flame retardant agent that can prevent the inflammation of the tape.

Other additives can be included in the composition of the tape, notably implementation agents such as thickeners, binders, spreading agents or pH-control agents.

Preferably, the tape further comprises a primary bonding layer located between the support and the adhesive composition layer. The purpose of this primary layer is to increase the adhesion of the adhesive composition on the support. The surface of the tape on which the primary bonding layer and the adhesive layer will be coated also preferably is subjected to a corona treatment between about 34 and about 46 dyne/cm. This treatment enables still better bonding of the adhesive composition on the support.

According to another embodiment, the tape is coated on the surface opposite the surface comprising the bonding layer and the adhesive composition layer(s) with an antiadherent layer which improves the ability to unroll the tape during use.

For automotive applications especially, the tape according to the invention in its total makeup of support and layers has a thickness preferably between about 70 and about 150 microns. Also, the adhesive tape may be used for the sheathing of a bundle of wires.

### EXAMPLE 1

Composition of the Support:

a) 69% by weight of an ethylene/propylene copolymer with an ethylene content of 22% and a melting point of 160° C.,

b) 20% by weight of an SEBS/SEB elastomer with a styrene content of 13%,

c) 6% by weight of carbon black,

d) 5% by weight of an antioxidant constituted of the mixture of pentaerythritol tetrakis (3-(3,5-di-tertiobutyl-4-hydroxyphenyl) propionate) with distearylthiodipropionate in a molar ratio of 1 to 4.

Production of the Support:

A support with a thickness of about 120 microns (between 100 and 140 microns) was obtained from this formulation by a standard extrusion blow-molding technique. One surface of the support was corona treated at a level between 42 and 46 dyne. Adhesive formulation:

a) 64.5% by weight of Ucécryl® WB 1465 distributed by UCB,

b) Additives: 0.5% by weight of Lumiten® ISC distributed by BASF (spreading agent), 1.5% by weight of Nopco® DSX 1514 distributed by Henkel (thickening agent), 0.5% by weight of 30% caustic soda (pH control agent),

c) 33% of water.

The adhesive formulation was spread on the treated surface of the support at the rate of 25 g/sec/m² by standard techniques known in the art. After evaporation of the water, the product was rolled up around a cardboard spindle. The final product was presented in the form of a roll of width and length selected according to the applications.

### EXAMPLE 2

Composition of the Support:

a) 74% by weight of an ethylene/propylene copolymer with an ethylene content of 22% and a melting point of 160° C.,

b) 20% by weight of an SEBS/SEB elastomer with a styrene content of 13%,

c) 4.75% by weight of carbon black,

d) 0.25% by weight of a primary antioxidant bis[3,3-bis (4′-hydroxy-3′-tert-butylphenyl)-butanaic acid] glycol ester,

e) 0.25% by weight of a secondary antioxidant tris-(2,4-ditert-butylphenyl)-phosphite,

f) 0.75% by weight of a second secondary antioxidant distearyl-3,3′-thiodipropionate.

Production of the Support:

A support with a thickness of about 85 microns (between 80 and 100 microns) was obtained from this formulation by a standard extrusion blow-molding technique.

Adhesive Formulation:

The same as Example 1.

### EXAMPLE 3

Composition of the Support:

a) 73% by weight of an ethylene/propylene copolymer with an ethylene content of 22% and a melting point of 160° C.,

b) 20% by weight of an SEBS/SEB elastomer with a styrene content of 13%,

c) 5% by weight of carbon black,

d) 0.4% by weight of a primary antioxidant bis [3,3-bis (4′-hydroxy-3′-tert-butylphenyl)-butanaic acid] glycol ester,

e) 0.4% by weight of a secondary antioxidant tris-(2,4-ditert-butylphenyl)-phosphite,

f) 1.2% by weight of a second secondary antioxidant distearyl-3,3′-thiodipropionate.

Production of the Support:

A support with a thickness of about 140 microns (between 130 and 150 microns) was produced from this formulation by a standard extrusion blow-molding technique.

Adhesive Formulation:

a) 63.75% by weight of Ucécryl WB 1465,

b) Additives:

0.5% by weight of Lumiten® ISC distributed by BASF (spreading agent),

1.5% by weight of Nopco DSX 1514 distributed by Henkel (thickening agent),

0.5% of 30% caustic soda (pH control agent),

0.25% by weight of bis[3,3-bis (4′-hydroxy-3′-tert-butylphenyl) butanaic acid] glycol ester (primary antioxidant),

0.25% by weight of tris-(2,4-ditert-butylphenyl)-phosphite (secondary antioxidant),

0.75% by weight of distearyl-3,3′-thiodipropionate (secondary antioxidant),

c) 33% of water.

1. A multilayer adhesive tape comprising:
a single-layer or multilayer support layer comprising a first polypropylene resin and/or an ethylene/propylene copolymer and at least a second polyehtylene resin, ethylene copolymer and/or elastomer, at least one of the resins being an elastomer; and
an adhesive composition layer adhered to at least one surface of the support layer, the support layer and/or the adhesive composition layer comprising at least one stabilizer.

2. The adhesive tape according to claim 1, wherein neither the support layer nor the adhesive composition layer contain halogen compounds.

3. The adhesive tape according to claim 1, wherein the content of ethylene monomer in the ethylene/propylene copolymer is between about 1.5 and about 50%, by weight.

4. The adhesive tape according to claim 1, wherein the support layer contains at least about 60% of a polypropylene resin and/or an ethylene/propylene copolymer.

5. The adhesive tape according to claim 1, wherein the elastomer resin is selected from the group consisting of a styrene-isoprene-styrene (SIS) resin, a styrene-ethylene-butadiene-styrene (SEBS) resin, a styrene-ethylene-butadiene (SEB) resin, a styrene-ethylene-butadiene-styrene/styrene-ethylene-butadiene (SEBS/SEB) resin, a styrene-butadiene-styrene (SBS) resin, an ethylene-propylene-diene monomer (EPDM) resin, an ethylene-propylene rubber (EPR) resin and mixtures thereof.

6. The adhesive tape according to claim 1, wherein the stabilizer is a temperature stabilizer, but excludes non-yellowing stabilizers.

7. The adhesive tape according to claim 1, wherein stabilizer is a primary antioxidant alone or is in combination with a secondary antioxidant.

8. The adhesive tape according to claim 7, wherein the primary antioxidant is a hindered phenol and/or a hindered amine.

9. The adhesive tape according to claim 7, wherein the secondary antioxidant is an organic phosphite or an organic phosphinite or an organic sulfide or a thio compound or a mixture thereof.

10. The adhesive tape according to claim 1, wherein the stabilizer is a hindered phenol combined with a phosphite or a thio compound.

11. The adhesive tape according to claim 1, wherein the stabilizer further comprises a high-performance antioxidant.

12. The adhesive tape according to claim 1, wherein the adhesive composition layer comprises neither natural nor synthetic rubber.

13. The adhesive tape according to claim 1, wherein the adhesive composition layer is pressure sensitive.

14. The adhesive tape according to claim 1, wherein the adhesive composition layer comprises an acrylic-based adhesive or a silicone-based adhesive.

15. The adhesive tape according to claim 1, wherein the adhesive composition layer is a hot melt or thermoset adhesive.

16. The adhesive tape according to claim 1, wherein the adhesive composition layer is cross-linkable under action of ultraviolet radiation or electron bombardment.

17. The adhesive tape according to claim 1, wherein the adhesive composition is selected from the group consisting of a hot melt acrylic adhesive that is cross-linkable under action of ultraviolet radiation, an adhesive in solution and an adhesive in an emulsion.

18. The adhesive tape according to claim 1, wherein the adhesive composition layer is modified by a tackifier resin, the content of tackifier resin being less than about 30% by weight in relation to the weight of the adhesive composition.

19. The adhesive tape according to claim 1, wherein the support and/or the adhesive composition layer further comprises colorants, mineral pigments and/or fillers selected from the group consisting of carbon black, zinc oxide, magnesium oxide, titanium oxide, calcium carbonate and talc.

20. The adhesive tape according to claim 1, wherein support and/or said adhesive composition layer comprises at least one halogen-free flame retardant agent.

21. The adhesive tape according to claim 20, wherein the halogen-free flame retardant agent is selected from the group consisting of alumina trihydrate, zinc borate, magnesium hydroxide, an organic polyphosphate, an ammonium polyphosphate, a triazine derivative and mixtures thereof.

22. The adhesive tape according to claim 1, further comprising a primary bonding layer located between the support and the adhesive composition layer.

23. The adhesive tape according to claim 22, further comprising a layer of an antiadherent agent on an opposite surface of the support layer.

24. The adhesive tape according to claim 23, wherein at least one surface of the support is subjected to a corona surface treatment between about 34 and about 46 dyne/cm prior to application of the antiadherent layer, the primary bonding layer and/or the adhesive composition layer.

25. The adhesive tape according to claim 1, having a thickness between about 50 and about 200 microns.

26. A bundle of wires sheathed with the adhesive tape according to claim 1.

27. A multilayer adhesive tape comprising:
a single-layer or multilayer support layer comprising a first polypropylene resin and/or an ethylene/propylene copolymer and at least a second polyehtylene resin, ethylene copolymer and/or elastomer, at least one of these resins being an elastomer; and
an adhesive composition layer adhered to at least one surface of the support layer, the support layer and/or the adhesive composition layer comprising at least one stabilizer,
wherein the tape substantially preserves physical properties at 125° C. for about 3000 hours and at 150° C. for about 240 hours.
